(19) United States
(12) Patent Application Publication
(10) Pub. No.: US 2009/0234829 A1
(43) Pub. Date: Sep. 17, 2009

(54) LINK BASED RANKING OF SEARCH RESULTS USING SUMMARIES OF RESULT NEIGHBORHOODS

(75) Inventors: Sreenivas Gollapudi, Cupertino, CA (US); Marc A. Najork, Palo Alto, CA (US); Rina Panigrahy, Sunnyvale, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/045,716

(22) Filed: Mar. 11, 2008

(51) Int. Cl. G06F 17/30

(52) U.S. Cl. 707/5; 707/E17.017

(57) ABSTRACT

A summary of the neighborhood of a page may be determined offline and used at query time to approximate the neighborhood graph of the result set and to compute scores using the approximate neighborhood graph. The summary of the neighborhood graph may include a Bloom filter containing a limited size subset of ancestors or descendants of the page. A web page identifier may also be included in the summary. Consistent sampling is used, where a consistent unbiased sample of a number of elements from the set is determined. At query time, given a result set, the summaries for all the results may be used to create a cover set. An approximate neighborhood graph consisting of the vertices in the cover set is created. Ranking technique scores may be determined based on the approximate neighborhood graph.

### BACKGROUND

It has become common for users of host computers connected to the World Wide Web (the “web”) to employ web browsers and search engines to locate web pages having specific content of interest to users. A search engine, such as Microsoft's Live Search, indexes tens of billions of web pages maintained by computers all over the world. Users of the host computers compose queries, and the search engine identifies pages that match the queries, e.g., pages that include key words of the queries. These pages are known as a “result set.” In many cases, ranking the pages in the result set is computationally expensive at query time.

A number of search engines rely on many features in their ranking techniques. Sources of evidence can include textual similarity between query and documents or query and anchor texts of hyperlinks pointing to documents, the popularity of documents with users measured for instance via browser toolbars or by clicks on links in search result pages, and hyper-linkage between web pages, which is viewed as a form of peer endorsement among content providers. The effectiveness of the ranking technique can affect the relative quality or relevance of pages with respect to the query, and the probability of a page being viewed.

### SUMMARY

A summary of the neighborhood may be determined for web pages and used at query time to approximate the neighborhood graph of the result set and to compute scores using the approximate graph. The summary of the neighborhood graph may include a summary of the ancestors (the pages that link to the web page) and a summary of the descendants (the pages that the web page links to). Each summary may include a Bloom filter containing a limited size subset of ancestors or descendants plus a smaller subset containing explicit web page identifiers. Consistent sampling may be used, where a consistent unbiased sample of a number of elements from a larger set is determined. At query time, given a result set, summaries for all the results in the result set are looked up and a cover set determined. A graph consisting of the vertices in the cover set is created, which is an approximation of the neighborhood graph of the result set. Ranking technique scores may be determined based on the approximate neighborhood graph.

In some implementations, an inlinking set may be consistently sampled, and an outlinking set may be consistently sampled. A summary of a web page may be determined based on the inlinking set and the outlinking set being consistently sampled. The summary may be determined as a Bloom filter of elements in the inlinking set and elements in the outlinking set.

In some implementations, a result set for a query may be received, and summaries for results within the result set may be determined. A cover set may be determined and approximate neighborhood graph may be determined. An authority score may also be determined. The summaries may be determined in advance of receiving the query by consistently sampling elements of an inlinking set to a uniform resource locator (URL) in the results and elements of an outlinking set from a URL in the results to determine the summaries.

In some implementations, a search engine may determine a summary for each page in a web graph based on an approximation of an inlinking set and an approximation of an outlinking set, the search engine receiving a query containing a search term and providing a result set responsive to the query. A database may store the summary for each page and a scoring engine may determine an authority score based on an approximate neighborhood graph determined based on the summary for each page.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific processes and instrumentalities disclosed. In the drawings:

FIG. 1 illustrates an exemplary environment;

FIG. 2 illustrates an exemplary process of ranking results to a query;

FIG. 3 illustrates an exemplary process of determining a summary database;

FIG. 4 illustrates an exemplary process performed at query time; and

FIG. 5 shows an exemplary computing environment.

### DETAILED DESCRIPTION

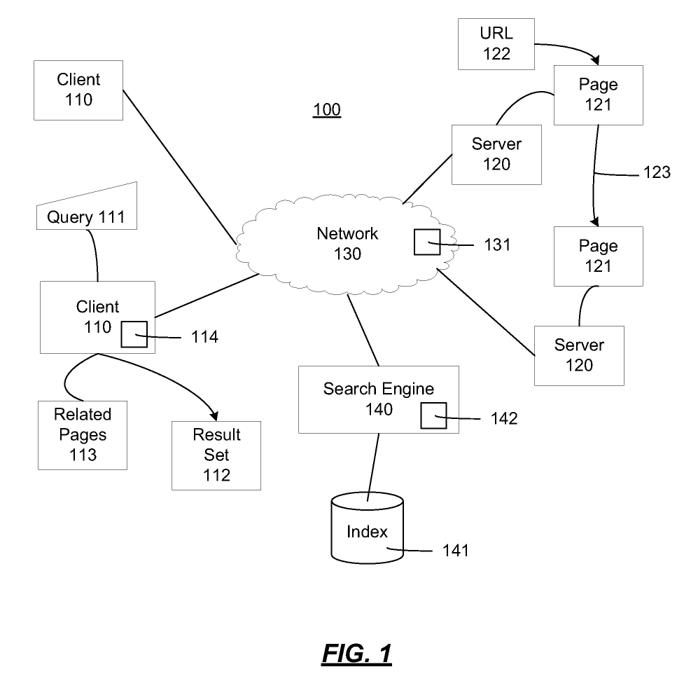

FIG. 1 illustrates an exemplary environment 100. The environment includes one or more client computers 110 and one or more server computers 120 (generally “hosts”) connected to each other by a network 130, for example, the Internet, a wide area network (WAN) or local area network (LAN). The network 130 provides access to services such as the World Wide Web (the “web”) 131. The web 131 allows the client computer(s) 110 to access documents containing text-based or multimedia content contained in, e.g., pages 121 (e.g., web pages or other documents) maintained and served by the server computer(s) 120. Typically, this is done with a web browser application program 114 executing in the client computer(s) 110. The location of each page 121 may be indicated by an associated uniform resource locator (URL) 122 that is entered into the web browser application program 114 to access the page 121. Many of the pages may include hyperlinks 123 to other pages 121. The hyperlinks may also be in the form of URLs.

Although the implementation is described with respect to documents that are pages, it should be understood that the environment can include any linked data objects having content and connectivity that may be characterized.

In order to help users locate content of interest, a search engine 140 may maintain an index 141 of pages in a memory, for example, disk storage, random access memory (RAM), or a database. In response to a query 111, the search engine 140 returns a result set 112 that satisfies the terms (keywords) of the query 111.

Because the search engine 140 stores many millions of pages, the result set 112, particularly when the query 111 is loosely specified, can include a large number of qualifying pages. These pages may or may not be related to the user's actual information needs. Therefore, the order in which the result set 112 is presented to the client 110 affects the user's experience with the search engine 140.

In an implementation, a ranking process may be implemented as part of a search engine 140 within a ranking engine 142. The ranking process may be based upon content analysis, as well as connectivity analysis, to improve the ranking of pages in the result set 112 so that just pages 113 related to a particular topic are identified.

As illustrated in FIG. 1, the pages 121 may be a linked collection. In addition to the textual content of the individual pages, the link structure of such collections may contain information which can be used when searching for authoritative sources. In an implementation, a link can suggest that users visiting page p follow the link and visit page q. This may reflect the fact that pages p and q share a common topic of interest. Such a link is called an informative or authoritative link, i.e., it is the way page p confers authority on page q. Informative links may provide a positive assessment of page q's contents from a source outside the control of the author of page q.

The vicinity of a page 121 may be defined by the hyperlinks that connect the page 121 to other pages. A page 121 may point to other pages, and the page 121 may be pointed to by other pages. Close pages are directly linked, and farther pages are indirectly linked via intermediate pages. This connectivity may be expressed as a graph where nodes represent the pages (e.g., a URL) and the directed edges represent the links (e.g., hyperlinks). The vicinity of the pages in the result set, up to a certain distance, may be called the neighborhood graph.

The well known “Stochastic Approach for Link-Structure Analysis” (SALSA) technique examines random walks on graphs derived from the link structure among pages in a search result. SALSA is a query dependent technique and takes the result set to a query as input and expands it to include pages at distance one in the web graph. SALSA is based upon the theory of Markov chains, and relies on the stochastic properties of random walks performed on a collection of sites to compute a hub score and an authority score for each node in the neighborhood graph. The SALSA technique initially assumes uniform probability over all pages, and relies on the random walk process to determine the likelihood that a particular page will be visited.

Another well known example of a query dependent technique is the HITS technique, which like SALSA, attempts to identify hub pages and authority pages in the neighborhood graph for a user query. Hubs and authorities exhibit a mutually reinforcing relationship.

Both HITS and SALSA are query dependent link-based ranking algorithms. Given a web graph (V, E) with vertex set V and edge set E ⊂ V×V (where edges/links between vertices/pages on the same web server are typically omitted), and the set of result URLs to a query (called the result set R ⊂ V) as input, both compute a base set R ⊂ V, defined to be:

$$B = R ⋃ {⋃}_{u ∈ R} \{ v ∈ V \text{:} ( u , v ) ∈ E \} ⋃ {⋃}_{v ∈ R} {S}_{n} [ \{ u ∈ V \text{:} ( u , v ) ∈ E \} ]$$

where Sₙ[X] denotes a uniform random sample of n elements from set X, and where Sₙ[X]=X if |X|<n.

The neighborhood graph may be defined as follows:

(B, N)

The neighborhood graph may have the base set as its vertex set and an edge set containing those edges in E that are covered by the base set and permitted by P:

N={(u,v) ε E:u ε B [symbol] v ε B}

Both HITS and SALSA determine the authority score A(u), estimating how authoritative u is on the topic induced by the query, and a hub score H(u), indicating whether u is a good reference to many authoritative pages. In an implementation of HITS, the hub scores and authority scores are computed in a mutually recursive fashion:

1. For all u ε B do

$$H ( u ) := \sqrt{\frac{1}{\vert B \vert}} , A ( u ) := \sqrt{\frac{1}{\vert B \vert}} .$$

2. Repeat until H and A converge:
(a) For all v ε B do A′(v):=Σ_{(u,v)εN}H(u)
(b) For all u ε B do H′(u):=Σ_{(u,v)εN}A(V)
(c) For all u ε B do

$$H ( u ) := \frac{1}{{‖ H ‖}_{2}} {H}^{′} ( u ) , A ( u ) := \frac{1}{{‖ {A}^{′} ‖}_{2}} {A}^{′} ( u )$$

In an implementation, SALSA computes the authority score A(u), estimating how authoritative u is on the topic induced by the query, as follows:

1. Let B^{A} be {uε B: in(u)>0}

2. For all uε B:

$$A ( u ) := \{ \begin{matrix}\frac{1}{\vert {B}^{A} \vert} & if u ∈ {B}^{A} \\ 0 & otherwise\end{matrix}$$

3. Repeat until A converges:

(a) For all uε B^{A}:

$${A}^{′} ( u ) = {\sum }_{( v , u ) ∈ N} {\sum }_{( v , w ) ∈ N} \frac{A ( w )}{out ( v ) in ( w )}$$

$$( b ) For all u ∈ {B}^{A} \text{:} A ( u ) := {A}^{′} ( u )$$

When performed on a web-scale corpus, both HITS and SALSA use a substantial amount of query time processing. Much of this processing is attributable to the computation of the neighborhood graph. The reason for this is that the entire web graph may be very large. A document collection of five billion web pages induces a set of about a quarter of a trillion hyperlinks. In some implementations, this web graph may be stored on disk or may be partitioned across many machines. In the former case, seek times may be unacceptably large, and in the later case, the cost of a link lookup is governed by the cost of a remote procedure call (RPC).

In an implementation, to lower the query time cost of HITS and SALSA, a portion of the computation performed in the HITS and SALSA techniques may be moved offline. At index construction time, a summary database mapping web page URLs to summaries of their neighborhoods may be constructed such that at query time, the results satisfying a query are ranked by looking up each result in the summary database. This operation uses one round of RPCs. The neighborhood graph is an approximation (i.e., summary) of the true neighborhood of the result set based on the neighborhood summaries of the constituent results. The SALSA or HITS scores may then be determined using that approximation of the neighborhood graph.

The summary of the neighborhood graph of a web page u consists of a summary of the ancestors (i.e., the pages that link to u) and a summary of the descendants (i.e., the pages that u links to), each consisting of a Bloom filter containing a limited size subset of ancestors or descendants plus a subset containing explicit web page identifiers (e.g., 64-bit integers). A Bloom filter is a space efficient probabilistic data structure that can be used to test the membership of an element in a given set; the test may yield a false positive, but never a false negative. A Bloom filter represents a set using an array A of m bits (where A[i] denotes the ith bit), and uses k hash functions h₁ to hₖ to manipulate the array, each hᵢ mapping some element of the set to a value in [1,m]. To add an element e to the set, A[hᵢ(e)] is set to 1 for each 1≦i≦k. To test whether e is in the set, it is verified that A[hᵢ(e)] is 1 for all 1≦i≦k. Given a Bloom filter size m and a set size n, the optimal (false-positive minimizing) number of hash functions k is

$$\frac{m}{n} ln 2.$$

Thus, the probability of false positives is

$${( \frac{1}{2} )}^{k} .$$

In an implementation, consistent sampling may be used to sample the neighborhood. Cₙ[X] may be used to denote a consistent unbiased sample of n elements from set X, with Cₙ[X]=X if |X|<n. Consistent sampling is deterministic in that when sampling n elements from a set X, the same n elements are drawn. Moreover, any element x that is sampled from set A is also sampled from subset B ⊂ A if x ε B. An example of consistent sampling is min-wise independent families of permutations. F ⊂ Sₙ is min-wise independent if for any set X ⊂ [n] and any x ε X , when π is chosen at random in F, then

$$Pr ( min \{ π ( X ) \} = π ( x ) ) = \frac{1}{\vert X \vert} .$$

In other words, all elements of any fixed set X have an equal chance to become the minimum element of the image of X under π.

The inlinking set I(u) is the set of web pages linking to page u (also called the ancestors of u); I(u)={v ε V: (v,u) ε E}. The outlinking set O(u) is the set of web pages that page u links to (also called the descendants of u), O(u)={v ε V: (u,v) ε E}. Pages may be represented as URLs, hashes of URLs, or integer values that uniquely identify URLs. Hashes and integer values allow for a more space-efficient and compact representation of either set.

For notational convenience, write Iₓ(u) as a shorthand for Cₓ[I(u)] (x consistently sampled ancestors of u), and write O_{y}(u) as a shorthand for C_{y}[O(u)] (y consistently sampled descendants of u).

For each page u in the web graph, the summary may be defined to be the triple:

(BF[Iₓ(u)], BF[O_{y}(u)], S_{z}[Iₓ(u) ∪ O_{y}(u)])

where the first element of the triple is a Bloom filter containing the set Iₓ(u) (x consistently sampled ancestors of u), the second element of the triple is a Bloom filter containing the set O_{y}(u) (y consistently sampled descendants of u), and the third element is a z-element subsample of the union of Iₓ(u) and O_{y}(u). The z-element subsample can be drawn using either uniformly random or consistent sampling. Given a summary triple for web page u, write BFI(u) to denote the first element of the triple, BFO(u) to denote the second element, and SSIO(u) to denote the third element. In an implementation, typical sampling values are 1000 for x and y, and 10 for z.

In an implementation, at query time, given a result set R, a lookup is performed for the summaries for all the results in R. Next, a cover set is determined as follows:

$$C = R ⋃ {⋃}_{u ∈ R} SSIO ( u )$$

A graph consisting of the vertices in C is constructed. The edges may be filled in as follows. For each vertex u ε R and each vertex v ε C, tests may be performed. If BFI(u) contains v, then an edge (v,u) is added to the graph. If BFO(u) contains v, then an edge (u,v) is added to the graph. The resulting graph serves as an approximation of the neighborhood graph of R, which may be used to compute SALSA or HITS scores using the computations described above.

The approximate neighborhood graph may differ from the exact neighborhood graph. In the exact graph, the vertices directly reachable from the result set are not sampled, rather they are all included. The approximate graph contains edges from C ∩ Iₓ(u) to u ε R and from u ε R to C ∩ O_{y}(u). In other words, it excludes edges between nodes in C that are not part of the result set. Also, approximations by Bloom filters rather than exact set representations for Iₓ(u) and O_{y}(u)are used. This may introduce additional edges, the number of which depends on the false positive probability of the Bloom filter. Using k hash functions, about 2^{-k+1}|C||R| spurious edges may be introduced in the graph.

In the implementations noted above, it is possible that the approximation may exclude actual edges due to the sampling process, and add phantom edges due to the potential for false positives inherent to Bloom filters. However, in accordance with the implementations, consistent sampling preserves co-citation relationships between pages in the result set.

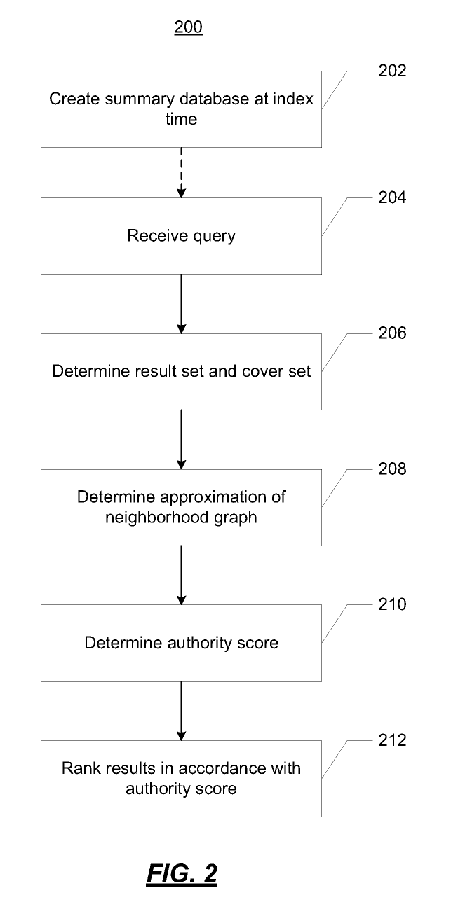

FIG. 2 illustrates an exemplary process 200 of ranking results to a query. At 202, a summary database is created. The summary database may be created by the search engine 140 at index time, and maps URLs to summaries of their neighborhoods. At 204, a query may be received. In an implementation, a query 111 may be received by the search engine 140 in FIG. 1. At 206, a result set and cover set are determined. At 208, an approximation of the neighborhood graph of query results may be determined. The search engine 140 may access the index 141 to determine results to the query where the results are pages (nodes) connected by hyperlinks (edges) represented by Bloom filters that satisfy the query terms.

At 210, an authority score may be determined. The authority score for each node (e.g., page) may be determined to estimate how authoritative each node is on the topic of the query. At 212, the results may be ranked. In an implementation, by applying the authority scores to each node, a ranking of the query results may be determined.

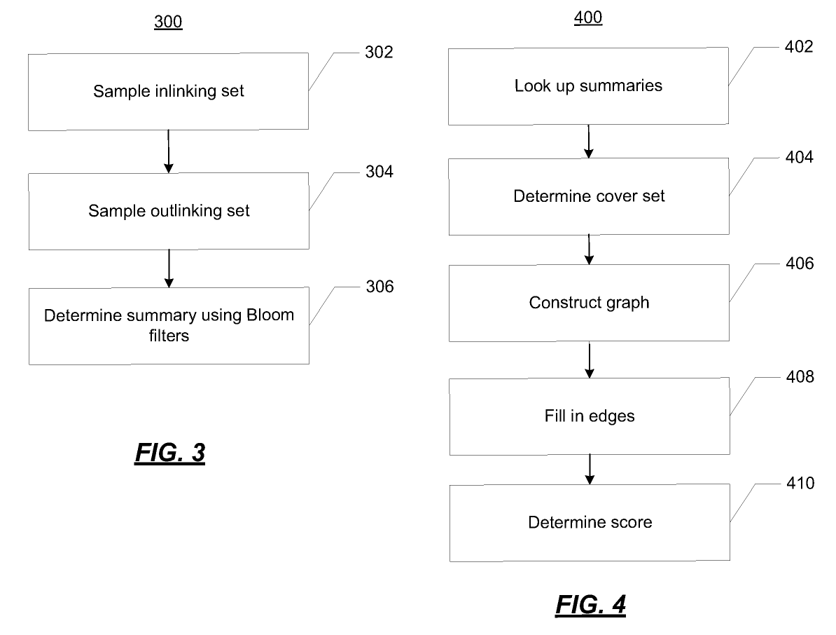

FIG. 3 illustrates an exemplary process 300 of determining the summary database. The process 300 may be repeated for each page u in the web graph stored in the summary database. The process 300 may also be performed at index time. At 302, the inlinking set is sampled. The search engine 140 may determine the set Iₙ(u) as a consistent sample Cₙ[{v ε V: (v,u) ε E}] of at most n of the ancestors of u. At 304, the outlinking set is sampled. The search engine 140 may determine the set Oₙ(u) as a consistent sample Cₙ[{v ε V: (u,v) ε E}] of n of the descendants of u.

At 306, the summary is determined. This may be determined as the triple (BFI(u),BFO(u),SSIO(u)); where BFI(u)=BF[Iₓ(u)] (a Bloom filter containing the set Iₓ(u), a consistent sample of x elements from the inlinking set of u), BFO(u)=BF[O_{y}(u)] (a Bloom filter containing the set O_{y}(u), a consistent sample of the outlinking set of u), and SSIO(u)=S_{z}[Iₓ(u) ∪ O_{y}(u)], a z-element subsample of the consistently sampled inlinkers and the consistently sampled outlinkers. The summary may be stored in the index 141.

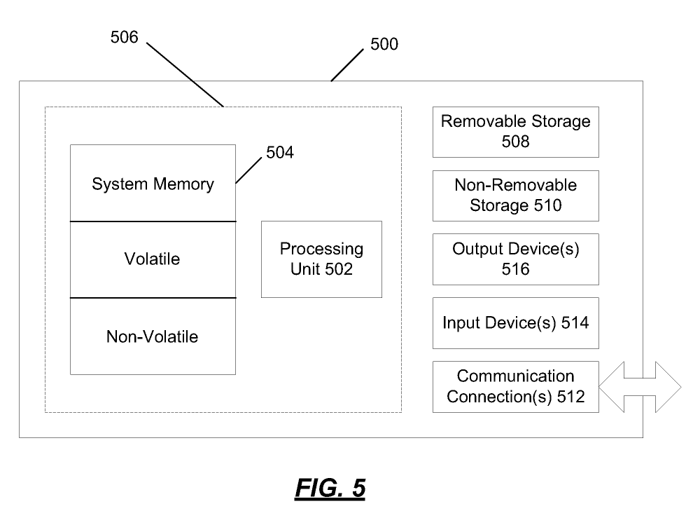

FIG. 4 illustrates an exemplary process 400 performed at query time. At 402, a lookup of the summaries is performed. Given a result set R to a query, a lookup is performed for the summaries for all the results in R stored in the index 141. At 404, a cover set is determined. The cover set may be determined as follows:

$$C = R ⋃ {⋃}_{u ∈ R} SSIO ( u )$$

At 406, a graph is constructed. The graph may consist of the vertices in C. At 408, edges of the graph are filled in. For each vertex u ε R and each vertex v ε C, if BFI(u) contains v, then an edge (v,u) is added to the graph. If BFO(u) contains v, then an edge (u,v) is added to the graph. At 410, a score is determined. The graph that results from 408 may be an approximation of the neighborhood graph of R, which may be used to compute SALSA or HITS scores.

Exemplary Computing Arrangement

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 500 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, comprising:
using consistent sampling to determine a summary of the neighborhood of each webpage of a plurality of webpages; and
estimating the relevance of results to a query using the summaries of the webpages corresponding to the results.

2. The method of claim 1, wherein the summary of each web page is based on a summary of the pages that link to a first page and a summary of pages that the first page links to.

3. The method of claim 2, further comprising:
consistently sampling x elements from a set of pages that link to the first page wherein the same x elements are sampled from the set each time the set is sampled; and
consistently sampling y elements from a set of pages that the first page links to wherein the same y elements are sampled from the set each time the set is sampled.

4. The method of claim 3, further comprising:
sampling x of the pages that link to the first page and y of the pages that the first page links to using min-wise independent hashing.

5. The method of claim 3, further comprising:
subsampling z elements from the consistent sample of x elements and the consistent sample of y elements.

6. The method of claim 5, further comprising:
representing the sampled elements using compact identifiers to denote web pages.

7. The method of claim 6, further comprising:
storing the sampled x elements from the set of pages that link to the first page in a first Bloom filter;
storing the sampled y elements from the set of pages that the first page links to in a second Bloom filter; and
storing the subsampled z elements in a list.

8. The method of claim 5, further comprising:
receiving a result set for the query;
determining summaries for the results within the result set;
determining a cover set as the union of the subsampled z elements contained in each summary;
determining an approximate neighborhood graph in accordance with vertices in the cover set; and
determining an authority score.

9. The method of claim 8, wherein the summaries are determined in advance of receiving the query.

10. The method of claim 8, wherein the authority score is determined using a Stochastic Approach for Link-Structure Analysis (SALSA) technique.

11. A computer-implemented method, comprising:
receiving a result set for a query;
determining a plurality of summaries for a plurality of results within the result set;
determining a cover set;
determining an approximate neighborhood graph; and
determining an authority score.

12. The method of claim 11, further comprising:
consistently sampling elements of an inlinking set to a uniform resource locator (URL) in the results and elements of an outlinking set from the URL in the results to determine the summaries.

13. The method of claim 12, further comprising:
determining a Bloom Filter for elements of the inlinking set and elements of the outlinking set; and
adding an edge to the approximate neighborhood graph if the Bloom filter of the inlinking set includes a vertex or if the Bloom filter of the outlinking set includes the vertex.

14. The method of claim 12, further comprising:
determining the approximate neighborhood graph using an approximation of the inlinking set and an approximation of the outlinking set to the URL; and
applying a Bloom filter to a subset of the inlinking set and to a subset of the outlinking set to determine the approximation of the inlinking set and the approximation of the outlinking set.

15. A computing system, comprising:
a search engine that determines a summary for each page in a web graph based on an approximation of an inlinking set and an approximation of an outlinking set, the search engine receiving a query containing a search term and providing a result set responsive to the query;
a database that stores the summary for each page; and
a scoring engine that determines an authority score based on an approximate neighborhood graph determined based on the summary for each page.

16. The computing system of claim 15, wherein consistently sampled elements of an inlinking set to a uniform resource locator (URL) associated with each page and consistently sampled elements of an outlinking set from the URL associated with each page are used to determine the summaries.

17. The computing system of claim 15, wherein a Bloom filter for elements of the approximation of the inlinking set and a Bloom filter of the elements of the approximation of the outlinking set is determined.

18. The computing system of claim 17, wherein an edge is added to the approximated neighborhood graph if the Bloom filter of the inlinking set includes a vertex or if the Bloom filter of the outlinking set includes the vertex.

19. The computing system of claim 15, wherein a Bloom filter is applied to a subset of the inlinking set and to a subset of the outlinking set to determine the approximation of the inlinking set and the approximation of the outlinking set.

20. The computing system of claim 19, wherein a web page identifier is added to the approximation of the inlinking set and to the approximation of the outlinking set.
